(19) United States
(12) Patent Application Publication
(10) Pub. No.: US 2016/0309761 A1
(43) Pub. Date: Oct. 27, 2016

(54) STABILIZED STEVIOL GLYCOSIDE IN CONCENTRATED SYRUP

(71) Applicant: CARGILL, INCORPORATED, Wayzata, MN (US)

(72) Inventors: Robert Joshua Brower, III, Clayton, OH (US); Ting liu Carlson, Marietta, SC (US); Aron Broman Erickson, Boulder, CO (US); Nathan Edward Knutson, Maple Grove, MN (US); Michael A. Porter, Maple Grove, MN (US)

(73) Assignee: Cargill, Incorporated, Wayzata, MN (US)

(21) Appl. No.: 15/104,605

(22) PCT Filed: Dec. 4, 2014
(86) PCT No.: PCT/US14/68552

§ 371 Date: Jun. 15, 2016

Related U.S. Application Data
(60) Provisional application No. 61/916,488, filed on Dec. 16, 2013.

(51) Int. Cl. A23L 27/30; A23L 29/10; A23L 29/30

(52) U.S. Cl. CPC A23L 27/33; A23L 29/30; A23L 29/10; A23V 2002/00

(57) ABSTRACT

A method for preparation of an acidic stabilized syrup concentrate containing rebaudioside B and a stabilizer additive. Acidic stabilized syrup concentrate compositions are also provided.

### FIELD OF THE INVENTION

The present invention relates to steviol glycosides. More specifically, the present invention relates to providing steviol glycosides in concentrated syrup.

### BACKGROUND OF THE INVENTION

Sugar alternatives are highly sought after for use in various food and beverage products. Steviol glycosides are sweet-tasting compounds extracted from the stevia plant (Stevia rebaudiana Bertoni) that are of particular interest.

WO2013/036366 describes a process for the preparation of highly soluble sweet glycosides from a Stevia rebaudiana Bertoni plant, and more particularly for preparation of highly soluble compositions containing rebaudioside D. This method for producing a sweetener comprises the steps of providing Stevia sweetener powder, solubilizing it in water under gradient temperature treatment conditions, to produce highly stable concentrated solution, and spray drying the highly stable concentrated solution to obtain a highly soluble Stevia sweetener powder.

### SUMMARY OF THE INVENTION

Steviol glycosides are sweet-tasting compounds extracted from the stevia plant (Stevia rebaudiana Bertoni). Rebaudioside A is one of the steviol glycosides that is widely used as a sweetener in beverages. Rebaudioside A has a sweetness potency of 250 times that of sucrose and an equilibrium solubility in water at about 8000 ppm. Rebaudioside A is known to have off-tastes, such as bitter, licorice, or lingering aftertaste. Blends of rebaudioside A and other steviol glycosides at specific ratios were found to significantly improve the taste quality over rebaudioside A alone. However, other common steviol glycosides found in the stevia leaves have much lower water solubility than rebaudioside A, which made it challenging to use in a concentrated syrup that is typically employed in the beverage industry. To incorporate steviol glycosides into a concentrated syrup, the solubility of the ingredient in the syrup should be at least 6 times higher than its desired concentration in the finished beverage. This report describes the discovery of certain additives that can increase the solubility of steviol glycosides, in particular, rebaudioside B, in an acidic solution.

It has been found that the use of rebaudioside B in concentrated syrups is particularly desirable due to the resulting sweetness and flavor profile of the final products prepared from such syrups. Preparation of such concentrated syrups comprising rebaudioside B is particularly challenging because the syrup must have a low pH to be properly used in most beverage applications.

In particular, a method is provided for preparation of an acidic stabilized syrup concentrate containing rebaudioside B comprising:
a) dissolving rebaudioside B in a solution having a pH of from about 7 to about 9 to form a syrup concentrate having a rebaudioside B concentration of at least 500 ppm;
b) adding a stabilizer additive selected from the group consisting of polyoxyethylene having from about 10 to about 100 oxyethylene repeating units that is etherifed with a C 16-19 alkyl alcohol;
sucrose monoesters of lauric, palmitic or stearic acid;
polysorbate comprising from about 20 to about 80 oxyethylene repeating units and esterified with a fatty acid selected from lauric acid, palmitic acid, stearic acid and oleic acid;
deoiled lecithins;
tannic acid;
polyoxyethylene octyl phenyl ether;
sodium dodecyl sulfate;
methyl cellulose;
   hydroxypropyl methyl cellulose;
   gum Arabic; and mixtures thereof to form a stabilized syrup concentrate; and
c) lowering the pH of the syrup concentrate to a pH of about 2 to about 5 to form an acidic stabilized syrup concentrate.

In an embodiment, the stabilizer additive is selected from the group consisting of polyoxyethylene (20) cetyl ether (such as Brij®58), polyoxyethylene (100) stearyl ether (such as Brij®S-100), polyoxyethylene (40) stearate (such as POE (40) stearate), tannic acid, a sucrose monoester of monopalmitate (such as Habo monoester P90), a sucrose monoester of palmitate/stearate having a ratio of stearate/palmitate of from 4:1 to 1:4 (such as Sisterna® SP50, Sisterna® SP70, and Sisterna® PS750), polyoxyethylenesorbitan monolaurate (such as Tween® 20), polyoxyethylenesorbitan monopalmitate (such as Tween® 40), polyoxyethylenesorbitan monostearate (such as Tween® 60), polyoxyethylene sorbitan monooleate (such as Tween® 80), polyoxyethylene octyl phenyl ether (Triton X-100), sodium dodecyl sulfate, methyl cellulose with molecular weight less than 100 (such as Methocel™ E15), hydroxypropyl methyl cellulose (such as Methocel™ E19), deoiled lecithins (such as Metarin CP and Lecigran 1000P), gum Arabic, and mixtures thereof.

Acidic stabilized syrup concentrates made by the present method are particularly useful as precursors to beverages as “throw syrups” due to their stability and unique compositional profile. The surprising ability to solubilize larger amounts of the usually difficult to solubilize rebaudioside B permits preparation of syrups having unique and excellent flavor profiles.

The present invention additionally provides acidic stabilized syrup concentrate compositions comprising rebaudioside B at a concentration of at least 500 ppm and stabilizer additive selected from the group consisting of

polyoxyethylene having from about 10 to about 100 oxyethylene repeating units that is etherifed with a C 16-19 alkyl alcohol;

sucrose monoesters of lauric, palmitic or stearic acid;

polysorbate comprising from about 20 to about 80 oxyethylene repeating units and esterified with a fatty acid selected from lauric acid, palmitic acid, stearic acid and oleic acid;

deoiled lecithins;

tannic acid;

polyoxyethylene octyl phenyl ether;

sodium dodecyl sulfate;

methyl cellulose;

hydroxypropyl methyl cellulose;

gum Arabic; and

mixtures thereof; the composition being at a pH from about 2 to about 5.

In one embodiment, the stabilizer additive of the acidic syrup concentrate is selected form the group consisting of polyoxyethylene (20) cetyl ether (such as Brij®58), polyoxyethylene (100) stearyl ether (such as Brij®S-100), polyoxyethylene (40) stearate (such as POE (40) stearate), tannic acid, a sucrose monoester of monopalmitate (such as Habo monoester P90), a sucrose monoester of palmitate/stearate having a ratio of stearate/palmitate of from 4:1 to 1:4 (such as Sisterna® SP50, Sisterna® SP70, and Sisterna® PS750), polyoxyethylenesorbitan monolaurate (such as Tween® 20), polyoxyethylenesorbitan monopalmitate (such as Tween® 40), polyoxyethylenesorbitan monostearate (such as Tween® 60), polyoxyethylene sorbitan monooleate (such as Tween® 80), polyoxyethylene octyl phenyl ether (Triton X-100), sodium dodecyl sulfate, methyl cellulose with molecular weight less than 100 (such as Methocel™ E15), hyroxypropyl methyl cellulose (such as Methocel™ E19), deoiled lecithins (such as Metarin CP and Lecigran 1000P), gum Arabic, and mixtures thereof.

In some embodiments, it was discovered that a stabilizer additive including a particular weight ratio of sucrose monoester to methyl cellulose proved particularly beneficial for allowing rebaudioside B to remain in solution. In an embodiment, the stabilizer additive comprises sucrose monoester and methyl cellulose at a weight ratio of from about 1:1 to about 5:1 sucrose monoester to methyl cellulose. In another embodiment, the stabilizer additive comprises sucrose monoester and methyl cellulose at a weight ratio of from about 2:1 to about 4:1 sucrose monoester to methyl cellulose. In yet another embodiment, the stabilizer additive comprises sucrose monoester and methyl cellulose at a weight ratio of about 3:1 sucrose monoester to methyl cellulose. In some of these embodiments, the sucrose monoester is sucrose monoester of monopalmitate and the methyl cellulose is hydroxypropyl methyl cellulose.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As noted above, the method comprises the step a) of dissolving rebaudioside B in a solution having a pH of from about 7 to 9, or in another embodiment from about 7 to 8, to form a syrup concentrate having a rebaudioside B concentration of at least 500 ppm. In an embodiment, the syrup concentrate has a rebaudioside B concentration of from about 500 ppm to about 3000 ppm. In an embodiment, the syrup concentrate has a rebaudioside B concentration of from about 600 ppm to about 1300 ppm. In an embodiment, the syrup concentrate has a rebaudioside B concentration of from about 700 ppm to about 1200 ppm. In an embodiment, the syrup concentrate has a rebaudioside B concentration of from about 800 ppm to about 1000 ppm.

Optionally, the syrup concentrate of step a) further comprises one or more additional steviol glycosides. Examples of steviol glycosides include rebaudioside A, rebaudioside C, rebaudioside D, rebaudioside E, rebaudioside F, stevioside, rubusoside, steviolbioside, steviolmonoside, and dulcoside A and mixtures thereof. These additional steviol glycosides are optionally each present at a concentration of from about 10 to about 8000 ppm. In an embodiment, the syrup concentrate of step a) further comprises one or more of rebaudioside A, rebaudioside C, rebaudioside D, rebaudioside E, rebaudioside F, stevioside, steviolbioside, and steviolmonoside. In an embodiment, the syrup concentrate of step a) further comprises rebaudioside A and rebaudioside D.

For purposes of the present invention, a stabilizer additive is an ingredient that provides an increase the amount of steviol glycoside that can be solvated in a composition at a given temperature as compared to a like composition that does not contain the stabilizer additive, or that permits steviol glycoside to remain solvated in a composition at a given temperature for a longer time than a like composition that does not contain the stabilizer additive. For purposes of the present invention, a “stabilized syrup concentrate” and an “acidic stabilized syrup concentrate” are compositions comprising a stabilizer additive in an amount effective to increase the amount of steviol glycoside that can be solvated in a composition at a given temperature as compared to a like composition that does not contain the stabilizer additive, or that permits steviol glycoside to remain solvated in a composition at a given temperature for a longer time than a like composition that does not contain the stabilizer additive.

In other embodiments, the stabilizer additives reduce sweet linger of steviol glycosides. For example, by combining stabilizer additives such as sucrose monoester and methylcellulose, these additives reduce sweet linger of steviol glycoside.

In an embodiment in step b), a stabilizer additive selected from the group consisting of polyoxyethylene (20) cetyl ether (such as Brij®58), polyoxyethylene (100) stearyl ether (such as Brij®S-100), polyoxyethylene (40) stearate (such as POE (40), tannic acid, a sucrose monoester of monopalmitate (such as Habo monoester P90), a sucrose monoester of palmitate/stearate having a ratio of stearate/palmitate of from 4:1 to 1:4 (such as Sisterna® SP50, Sisterna® SP70, and Sisterna® PS750), polyoxyethylenesorbitan monolaurate (such as Tween® 20), polyoxyethylenesorbitan monopalmitate (such as Tween® 40), polyoxyethylenesorbitan monostearate (such as Tween® 60), polyoxyethylene sorbitan monooleate (such as Tween® 80), polyoxyethylene octyl phenyl ether (Triton X-100), sodium dodecyl sulfate, methyl cellulose with molecular weight less than 100 (such as Methocel™ E15), hydroxypropyl methyl cellulose (such as Methocel™ E19), deoiled lecithins (such as Metarin CP and Lecigran 1000P), gum arabic, and mixtures thereof to form a stabilized syrup concentrate.

In a preferred embodiment, an additive is selected from the group of sucrose monoesters and hydroxypropyl methyl cellulose, such as Habo monoester P90, Methocel E19, Tween 80, 7LF carboxymethyl cellulose, and SP70 sucrose ester.

In an embodiment, the stabilizer additive is selected from the group consisting of tannic acid, a sucrose monoester of palmitate/stearate having a ratio of stearate/palmitate of from 4:1 to 1:4, polyoxyethylene (20) cetyl ether, and mixtures thereof.

In some embodiments, it was discovered that a stabilizer additive including a particular weight ratio of sucrose monoester to methyl cellulose proved particularly beneficial for allowing rebaudioside B to remain in solution. The term “ratio” when used in reference to the stabilizer additive refers to the weight ratio. “Weight ratio” refers to the ratio of two components in a composition on a weight basis. The concentration of other ingredients in the composition are not used, and do not affect, the weight ratio calculation. For example, if 10 grams of component A and 20 grams of component B are used in a composition, the weight ratio of components A to B is 0.5. In an embodiment, the stabilizer additive comprises sucrose monoester and methyl cellulose at a weight ratio of from about 1:1 to about 5:1 sucrose monoester to methyl cellulose. In another embodiment, the stabilizer additive comprises sucrose monoester and methyl cellulose at a weight ratio of from about 2:1 to about 4:1 sucrose monoester to methyl cellulose. In yet another embodiment, the stabilizer additive comprises sucrose monoester and methyl cellulose at a weight ratio of about 3:1 sucrose monoester to methyl cellulose. In some of these embodiments, the sucrose monoester is sucrose monoester of monopalmitate and the methyl cellulose is hydroxypropyl methyl cellulose.

In an embodiment, the ratio of rebaudioside B present in the stabilized syrup concentrate to stabilizer additive present in the stabilized syrup concentrate of step b) is from about 1:0.1 to about 1:1 by weight. In an embodiment, the ratio of rebaudioside B to stabilizer additive in step b) is from about 1:0.3 to about 1:0.8 by weight.

In an embodiment, the ratio of steviol glycosides present in the stabilized syrup concentrate to stabilizer additive present in the stabilized syrup concentrate of step b) is from about 1:0.1 to about 1:1 by weight. In an embodiment, the ratio of steviol glycosides to stabilizer additive in step b) is from about 1:0.3 to about 1:0.8 by weight.

In an embodiment, the stabilizer additive is added by first preparing a stabilizer additive stock solution comprising from about 0.5% to about 50% by weight of the stabilizer additive in water, and mixing the stabilizer additive stock solution with the syrup concentrate in an amount effective to achieve a desired steviol glycoside to stabilizer additive weight ratio in the stabilized syrup concentrate. This mixing is, in an embodiment, carried out under thorough mixing conditions at from about 15° C. to about 35° C. In an embodiment, the mixing is carried out by a vortex mixer or a homogenizer. In step c), the pH of the syrup concentrate is lowered to a pH of 2-5 to form an acidic stabilized syrup concentrate. In an embodiment, the pH of the stabilized syrup concentrate is lowered to a pH of 2-4 to form an acidic stabilized syrup concentrate. In an embodiment, the pH of the stabilized syrup concentrate is lowered to a pH of 2-3 to form an acidic stabilized syrup concentrate. In an embodiment, the pH of the stabilized syrup concentrate is lowered in step c) by addition of a buffer solution. In an embodiment, buffer solution comprises an acid selected from the group consisting of citric acid, malic acid, lactic acid, phosphoric acid, tartaric acid, and mixtures thereof. In an embodiment, buffer solution comprises sodium citrate and sodium benzoate. In an embodiment, the mixing in step c) is carried out under thorough mixing conditions.

In an embodiment, steps a), b) and c) are independently carried out at a temperature of from about 15° C. to about 45° C.

The present method may further comprise a step d) of removing undissolved solids from the acidic stabilized syrup concentrate. In an embodiment, the removal of undissolved solids comprises the steps of centrifugation and filtration. In an embodiment, the removal of undissolved solids comprises the step of decanting a supernatant with subsequent filtration.

In an embodiment, the acidic stabilized syrup concentrate is stored without mixing for a period of time of about 4 to 60 hours, or from about 10 to 50 hours, or from about 18 to 40 hours prior to centrifugation or decanting and/or after centrifugation or decanting and prior to filtration. In an embodiment, this storage is carried out at a temperature of from about 0° C. to about 45° C. or from about 3° C. to about 15° C.

In an embodiment, the step of centrifugation of the acidic stabilized syrup concentrate is carried out at a centrifuge rate of from about 1000 to about 40,000 rpm, or at a centrifuge rate of from about 5000 to about 30,000 rpm, or at a centrifuge rate of from about 8000 to about 15,000 rpm. In an embodiment, the step of centrifugation of the acidic stabilized syrup concentrate is carried out at any of the above rates for a time of from about 1 minute to about 20 minutes, or for a time of from about 2 minute to about 10 minutes, or for a time of from about 3 minute to about 8 minutes.

In an embodiment, the undissolved solids are filtered using a filter having a pore size of less than or equal to about 1 micron. In an embodiment, the undissolved solids are filtered using a filter having a pore size of from about 0.8 to about 0.1 microns. In an embodiment, the undissolved solids are filtered using a filter having a pore size of from about 0.7 to about 0.22 microns. In an embodiment, the undissolved solids are filtered using a filter having a pore size of from about 0.55 to about 0.35 microns.

In an embodiment, the acidic stabilized syrup concentrate is substantially free of undissolved solids that will not pass through a filter having a pore size of 1 micron. In an embodiment, the acidic stabilized syrup concentrate is substantially free of undissolved solids that will not pass through a filter having a pore size of 0.8 micron, or alternatively of 0.7 micron, or alternatively of 0.45 micron, or alternatively of 0.3 micron, or alternatively of 0.22 micron. In an embodiment, step d) is carried out at a temperature of from about 15° C. to about 45° C.

Optionally, the acidic stabilized syrup concentrate may comprise additional ingredients, such as flavorants, preservatives, emulsifiers, colorants, nutritive sweeteners, high intensity sweeteners, vitamins, mineral salts, and clouding agents. In an embodiment, the flavorant is selected from the group consisting of lemon, lime, orange, grape, lemon-lime, cola, root beer, peach, kiwi, and mixtures thereof.

The optional additional ingredients may be added at any stage in the process of preparation of the acidic stabilized syrup concentrate. In an embodiment, the optional additional ingredients are added after step d) of removing undissolved solids from the acidic stabilized syrup concentrate.

The acidic stabilized syrup concentrates as described herein are in one embodiment incorporated into beverage compositions. Thus, the present disclosure also contemplates beverage compositions that include the sweetener compositions of the present disclosure. Examples of beverages include carbonated soft drinks, ready to drink teas, sports drinks, dairy drinks, yogurt-containing drinks, alcoholic beverages, energy drinks, flavored waters, vitamin drinks, fruit drinks, and fruit juices.

Representative embodiments of the present invention will now be described with reference to the following examples that illustrate the principles and practice of the present invention.

### Example 1

A series of syrup solutions were prepared (on a w/w basis) targeting 0.26% steviol glycosides (including approximately 800 ppm rebaudioside B) in 0.05 M citrate buffer at pH 3.2. The solutions also contained 17.7% sucrose, 0.085% sodium benzoate, and 1% flavor (lemon lime flavor from Kerry group, New Jersey). To these solutions, varying amounts of sucrose monoester of monopalmitate (Habo monoester P90) from Compass Foods, Singapore) and/or hydroxypropyl methyl cellulose (Methocel™ E19 from DOW Chemical, Michigan) were added as listed in Table 1 below. For example, solution 1 includes a 3:1 weight ratio of sucrose monoester of monopalmitate to hydroxypropyl methyl cellulose, while solution 4 includes a 1:1 weight ratio. Other solutions include alternative weight ratios. The solutions were then stored at 6° C. for four days. Precipitate formation is noted in Table 3 over time. On the fourth day a sample of supernatant was filtered through a 0.45 μm filter and analyzed by liquid chromatography.

TABLE 1
Additive addition to syrup samples.

| | | Sucrose monoester | |
|---|---|---|---|
| | Total additive | of monopalmitate | Hydroxypropyl methyl |
| | concentration | concentration | cellulose concentration |
| Solution | (ppm) | (wt %) | (wt %) |
| Control | 0 | 0 | 0 |
| 1 | 224 | 75 | 25 |
| 2 | 224 | 100 | 0 |
| 3 | 224 | 0 | 100 |
| 4 | 224 | 50 | 50 |
| 5 | 224 | 25 | 75 |

An Agilent Zorbax Eclipse plus C18 column (1.8 um, 3.0×150 mm) was used for steviol glycoside analysis using a gradient as described below in Table 2. The column is maintained at 45° C.

TABLE 2

| | 0.01M phosphate | |
|---|---|---|
| Time (minutes) | buffer, pH = 2.6 | Acetonitrile |
| 0 | 80% | 20% |
| 7.0 | 70% | 30% |
| 11.0 | 69% | 31% |
| 16.0 | 45% | 55% |
| 18.0 | 20% | 80% |
| 20.0 | 20% | 80% |
| 20.1 | 80% | 20% |
| 25.0 | 80% | 20% |

TABLE 3
Solution stability observation over four days.

| Solution | Day 1 | Day 2 | Day 3 | Day 4 |
|---|---|---|---|---|
| Control | Heavy | Heavy | Heavy | Heavy |
| | Precipitation | Precipitation | Precipitation | Precipitation |
| 1 | Clear | Clear | Clear | Clear |
| 2 | Clear | Slight | Precipitate | Precipitate |
| | | Precipitation | | |
| 3 | Heavy | Heavy | Heavy | Heavy |
| | Precipitation | Precipitation | Precipitation | Precipitation |
| 4 | Clear | Very slight | Very slight | Very slight |
| | | Precipitation | Precipitation | Precipitation |
| 5 | Clear | Precipitate | Precipitate | Precipitate |

TABLE 4
Glycoside analysis of the solution supernatant
held at 6° C. after four days.

| Solution | Reb B (ppm) | Total Steviol Glycosides (ppm) |
|---|---|---|
| Control | 341 | 2103 |
| 1 | 790 | 2611 |
| 2 | 718 | 2540 |
| 3 | 496 | 2268 |
| 4 | 764 | 2555 |
| 5 | 697 | 2482 |

Solution 1 had the greatest stability with no precipitate observed over 4 days and also had the greatest amount of steviol glycosides remaining in solution. The combinations of sucrose monoester of monopalmitate and hydroxypropyl methylcellulose gum had the greatest stability vs. control or solutions with only one additive. More specifically, the 3:1 weight ratio of sucrose monoester of monopalmitate and hydroxypropyl methylcellulose gum showed the greatest stability over other combinations. All the combinations in the solution enhance the solubility of rebaudioside B having weight ratios of about 1:1 to about 5:1 of sucrose monoester of monopalmitate and hydroxypropyl methylcellulose gum, respectively. A preferred weight ratio is about 3:1 of sucrose monoester of monopalmitate to hydroxypropyl methylcellulose.

### Example 2

A series of test solutions containing increasing amounts of rebaudioside B were prepared. Each test solution contained a 3:1 combination of sucrose monoester of monopalmitate and hydroxypropyl methylcellulose. Control samples were also prepared without sucrose monoester of monopalmitate and hydroxypropyl methylcellulose. The targeted amounts of rebaudioside B were 350 ppm, 425 ppm, and 500 ppm (w/w) in a 0.05M citric acid buffer at pH 3.1 in solution 1, 2, and 3, respectively. The test solutions all contained 180 ppm sucrose monoester of monopalmitate and 60 ppm hydroxypropyl methylcellulose gum (w/w). On day 3 the solutions were observed for precipitate, filtered, and analyzed for rebaudioside B. The results are listed in Table 5.

TABLE 5
Rebaudioside B concentration comparing solutions with
and without the addition of additives after 3 days.
Rebaudioside B Concentration (ppm)

| | Solution 1 | Solution 2 | Solution 3 |
|---|---|---|---|
| Control | 319 | 295 | 151 |
| Test | 354 | 419 | 513 |

All three test solutions containing sucrose monoester of monopalmitate and hydroxypropyl methylcellulose gum had higher rebaudioside B concentrations remaining in solution than the controls after 3 days of storage. The test solutions contained a 3:1 ratio of sucrose monoester of monopalmitate and hydroxypropyl methylcellulose.

### Example 3

Solutions were prepared (on a w/w basis) with 0.3% steviol glycosides, 17.7% sucrose, and 0.09% benzoate in a 0.05M citrate buffer at pH 3.1. These solutions had various combinations of additives listed in Table 6 below to determine enhanced solubility. Habo monoester P90 was purchased from Compass Foods; Methocel E19 hydroxypropyl methyl cellulose from DOW, Michigan; 7LF carboxymethyl cellulose from Ashland, Del.; Tween 80 from Croda; gum Arabic from TIC Gums, Maryland; and SP70 sucrose ester from Sisterna B.V., Netherlands. Additive 1 was added at 170 ppm (w/w) and additive 2 was added at 57 ppm (w/w). The solutions were stored for 3 days and observed for precipitate formation.

TABLE 6
Additive combinations utilized to enhance long term solubility of 0.3%
steviol glycosides in a 0.05M citrate solution.

| Solution | Additive 1-170 ppm | Additive 2-57 ppm |
|---|---|---|
| 1 | Habo monoester P90 | Methocel E19 |
| 2 | Tween 80 | Methocel E19 |
| 3 | Habo monoester P90 | 7LF carboxymethyl cellulose |
| 4 | Habo monoester P90 | gum Arabic |
| 5 | SP70 sucrose ester | Methocel E19 |

TABLE 7
UZ,7/26 Observations of the solutions after 3 days.

| Solution | Day 3 Observation |
|---|---|
| 1 | Very slight precipitate |
| 2 | Heavy precipitate |
| 3 | Precipitate |
| 4 | Precipitate |
| 5 | Precipitate |

The best combinations of the additives tested were the sucrose monoester of monopalmitate and hydroxypropyl methyl cellulose of solution 1 for maintaining steviol glycosides in solution. Solution 1 contained about a weight ratio of 3:1 of sucrose monoester of monopalmitate to hydroxypropyl methyl cellulose. Combinations of the sucrose monoester of monopalmitate or hydroxypropyl methyl cellulose with other additives did not prevent the same concentration of steviol glycoside from precipitation in 3 days.

### Example 4

A series of lemon-lime flavored sodas were prepared for sensory evaluation. These solutions contained (on a w/w basis) 3.12% sucrose, 0.26% steviol glycosides, 0.015% sodium benzoate, 0.018% flavor, and 0.01M citric acid at pH 3.2. In addition, these solutions contained varying amounts of sucrose monoester of monopalmitate (Habo monoester P90) and hydroxypropyl methyl cellulose gum (Methocel E19) to determine the impact of sensory perception of sweet linger. The concentrations are listed in Table 8. The solutions were evaluated by 3 panelists and the summary of the sensory observations is listed in Table 9.

TABLE 8
Concentrations of sucrose monoester of monopalmitate and
hydroxypropyl methylcellulose gum in soda formulations.

| Solution | Habo monoester P90 (ppm) | Methocel E19 (ppm) |
|---|---|---|
| Control | 0 | 0 |
| 1 | 10 | 10 |
| 2 | 20 | 10 |
| 3 | 30 | 10 |

TABLE 9
Summary of the sensory observations of the soda solutions
containing Habo monoester P90 and Methocel E19.

| Sample | Sweet Linger |
|---|---|
| Control | 6—long sweet linger |
| 1 | 4—slight sweet linger |
| 2 | 2—very slight sweet linger |
| 3 | 0—no sweet linger |

As the concentration of sucrose monoester of monopalmitate increased the sweet linger of the steviol glycosides decreased. As shown, a ratio of 1:1 resulted in a slight sweet linger and a ratio of 3:1 resulted in no sweet linger. The ratio of 2:1 sucrose monoester of monopalmitate to hydroxypropyl methylcellulose was preferred, which resulted in a very slight sweet linger.

### Example 5

A series of syrup solutions were prepared (on a w/w basis) targeting 0.22% steviol glycosides (including approximately 750 ppm reb B) in 0.05M acidic citrate buffer at pH 3.2. The solutions also contained 20.4% sucrose, 0.085% sodium benzoate, and 1% flavor (lemon lime flavor from Kerry group, New Jersey). To these solutions, varying amounts of sucrose monoester of monopalmitate (Habo monoester P90 from Compass Foods, Singapore) and/or hydroxypropyl methyl cellulose (Methocel E19 from DOW Chemical, Michigan) were added as listed in Table 10 below. The solutions were then stored at 6° C. for four days and observed if a precipitate was formed (Table 11).

TABLE 10
Additive addition to the solutions.

| | Sucrose monoester of | Hydroxypropyl |
|---|---|---|
| Solution | monopalmitate (ppm) | Methylcellulose (ppm) |
| Control | 0 | 0 |
| A | 112 | 56 |
| B | 56 | 56 |

TABLE 11
Solution stability observation over four days,

| Solution | Day 1 | Day 2 | Day 3 | Day 4 |
|---|---|---|---|---|
| Control | Precipitate | Heavy | Heavy | Heavy |
| | | Precipitate | Precipitate | Precipitate |
| A | Clear | Clear | Clear | Clear |
| B | Clear | Clear | Clear | Clear |

The solutions containing additives were able to remain soluble through 4 days of storage. A ratio of 1:1 to 2:1 of sucrose monoester of monopalmitate to hydroxypropyl methylcellulose is preferred.

### Example 6

A stock solution (on a w/w basis) of 3% mixed steviol glycoside and 0.9% sodium benzoate solution was prepared. The pH of the stock solution is adjusted to pH 7.5 with sodium hydroxide to fully dissolve all the steviol glycosides.

All the emulsifiers and additives listed in Table 13 were made in a 1% stock solution in water. The pH of the emulsifiers was not adjusted.

A 1 M citric acid buffer at pH 2 was also prepared.

Each experiment was conducted according to the procedure below. 0.1 ml of steviol glycoside stock solution was mixed with 0.1-0.25 ml of the listed additives and deionized water to a total volume of 0.95 ml. The solution was mixed for 5 seconds by vortex at room temperature. 0.05 ml of 1 M citric acid buffer, pH 2, was added to each solution to bring the pH down to about pH 2.5. The solution was mixed for another 5 seconds before storing at 4° C. for 1-2 days. The samples were spun down at 10,000 rpm for 5 minutes and filtered through a 0.45 micron filter before analysis by HPLC. The steviol glycoside content in the supernatant is listed in table 13 below.

A Shiseido Capcell PAK C18 column, type MGII, (5 um, 4.6×250 mm) is used for steviol glycoside analysis using a gradient as described in Table 12. The column is maintained at 55° C.

TABLE 12

| | 0.01M | |
|---|---|---|
| | phosphate | |
| | buffer, | |
| Time | pH = 2.6 | Acetonitrile |
| 0 | 80% | 20% |
| 5.5 | 80% | 20% |
| 8 | 70% | 30% |
| 11 | 70% | 30% |
| 14.5 | 65% | 35% |
| 23 | 65% | 35% |
| 26.5 | 20% | 80% |
| 29 | 20% | 80% |
| 31.5 | 80% | 20% |
| 33.5 | 80% | 20% |

As compared to control with no additives, 0.1% of emulsifiers or tannic acid increased the solubility of steviol glycosides in acidic solution. The main increase is in the solubility of rebaudioside B, which has a very low solubility at pH 2.5. The additives increased the solubility of rebaudioside B 2-3 fold. The best additives in this study are tannic acid and Brij 58 (polyoxyethylene (20) cetyl ether), followed by Tween 20.

TABLE 13
Steviol glycoside concentration in supernatant after
storage at 4° C. for 20 hours.

| | | ppm | | | |
|---|---|---|---|---|---|
| | Conc. | RA | stv | RB | total |
| Tween 20 | 0.10% | 1449 | 104 | 636 | 2189 |
| (polyoxyethylenesorbitan | | | | | |
| monolaurate) | | | | | |
| Tween 40 | 0.10% | 1482 | 107 | 564 | 2153 |
| (polyoxyethylenesorbitan | | | | | |
| monopalmitate) | | | | | |
| Tween 60 | 0.10% | 1501 | 109 | 552 | 2161 |
| (polyoxyethylenesorbitan | | | | | |
| monostearate) | | | | | |
| Tween 80 | 0.10% | 1482 | 107 | 529 | 2119 |
| (polyoxyethylenesorbitan | | | | | |
| monooleate) | | | | | |
| Tannic acid | 0.10% | 1514 | 108 | 919 | 2541 |
| Brij 58 (polyoxyethylene | 0.10% | 1519 | 106 | 943 | 2568 |
| (20) cetyl ether) | | | | | |
| Brij S-100 (polyoxyethylene | 0.10% | 1439 | 104 | 534 | 2077 |
| (100) stearyl ether) | | | | | |
| POE(40) stearate | 0.10% | 1490 | 109 | 549 | 2148 |
| control | | 1424 | 105 | 341 | 1869 |

RA = rebaudioside A,
stv = stevioside,
RB = rebaudioside B.

### Example 7

The experiment is conducted according to the procedure set out in Example 6, except for the mixed steviol glycoside stock solution, which also contains rebaudioside D. Each experiment contains the following components: 0.15 ml of 3% stock steviol glycoside solution, 0.1 ml of 1% additive or emulsifiers listed in Table 14, 0.75 ml of deionized water. The solution was mixed for 5 seconds by vortex before being acidified with the addition of 0.05 ml of 1 M citric acid buffer, pH 2. The solution was mixed again for 5 seconds and stored at 4° C. for 20 hours before analysis by HPLC.

The concentration of steviol glycosides in the supernatant is listed in Table 14 below.

Table 14 shows that all treatments with additives increased the solubility of rebaudioside D and rebaudioside A and rebaudioside B, compared to the control, but the impact on rebaudioside B was the greatest. The most effective additives for rebaudioside B as shown in this table are Sisterna PS750, Sisterna SP70, Brij 58, and tannic acid. Sisterna PS750 is a 75% monoester of palmitate/stearate. Sisterna SP70 is a 70% monoester of stearate/palmitate.

TABLE 14
Solubility of Rebaudioside D, Rebaudioside A, and Rebaudioside B.

| | RebD | RebA | | | | |
|---|---|---|---|---|---|---|
| | (ppm) | (ppm) | RebB (ppm) | RebD | RebA | RebB |
| Control | 1088 | 1140 | 373 | 100.00% | 100.00% | 99.99% |
| Sisterna SP50 | 1186 | 1240 | 560 | 109.04% | 108.72% | 150.21% |
| Sisterna SP70 | 1204 | 1259 | 705 | 110.43% | 110.42% | 189.10% |
| Sisterna PS750 | 1219 | 1272 | 872 | 112.05% | 111.51% | 233.91% |
| Tween20 | 1203 | 1263 | 571 | 110.53% | 110.80% | 153.20% |
| Tween40 | 1206 | 1267 | 640 | 110.88% | 111.15% | 171.69% |
| Tween60 | 1205 | 1262 | 622 | 110.73% | 110.67% | 166.75% |
| Tween80 | 1193 | 1254 | 619 | 109.69% | 109.95% | 165.96% |
| Tannic Acid | 1195 | 1260 | 731 | 109.87% | 110.47% | 196.02% |
| Brij 58 | 1205 | 1266 | 908 | 110.80% | 111.05% | 243.54% |
| Brij 100 | 1191 | 1247 | 613 | 109.48% | 109.38% | 164.39% |
| POE(40)stearate | 1205 | 1260 | 606 | 110.71% | 110.49% | 162.54% |

### Example 8

A 0.3% solution of mixed steviol glycoside was prepared according to the procedure set out in Example 6 and mixed with 0.1% of Brij 58, PS750, or tannic acid at pH 2.5 with 0.05 M citric acid buffer. The solution was mixed continuously in a rotating mixer for 20 hours at room temperature. After 20 hours, the solution was maintained at 4° C. for another 24 hours without mixing. The concentration of steviol glycosides in solution was determined by separating the supernatant from precipitate by filtration through a 0.45 micron filter and diluting the supernatant 1:6 with deionized water. The concentration of steviol glycosides in solution was measured by HPLC as described above.

There is little change in the concentration of rebaudioside A, stevioside, or rebaudioside D, but stabilization additives had a significant effect on the concentration of rebaudioside B in solution. In a control solution without any stabilization additives, the solution concentration of rebaudioside B continues to decrease throughout the day. Rebaudioside B precipitate was readily visible within 5 minutes of preparation. Solutions made with 0.1% stabilization additives showed a constant rebaudioside B concentration for 20 hours. By 44 hours, the 0.1% Brij 58 or PS750 samples still kept rebaudioside B in solution while some of the rebaudioside B was precipitated out of solution in the 0.1% tannic acid sample. The results as reported in Table 15 showed that the stabilization additives prevented rebaudioside B from crystallizing out of solution under acidic conditions.

TABLE 15

Reb B in solution (ppm)

| Time | Control | Brij 58 | SP750 | Tannic acid |
|---|---|---|---|---|
| 1 h | 608 | 917 | 890 | 907 |
| 4 h | 419 | 950 | 940 | 937 |
| 20 h | 347 | 941 | 930 | 929 |
| 44 h | 336 | 952 | 942 | 852 |

### Example 9

A 0.3% solution of mixed steviol glycoside was prepared according to the procedure set out in Example 6. 0.01%, 0.05% or 0.1% of tannic acid was mixed with the mixed steviol glycoside solution at pH 2.5. After mixing, the vials were stored at 4° C. for 8 hours before analysis. The concentration of steviol glycosides in the supernatant was measured by HPLC after filtering away precipitates in the solution and diluting 1:6 with deionized water. The level of increase in each glycoside is shown in Table 16 below. There is a dose response between tannic acid concentration in the solution and the amount of soluble rebaudioside B. The effect on rebaudioside A and rebaudioside D is minimal.

TABLE 16

| | Percentage | | |
|---|---|---|---|
| RA | RA | RB | RD |
| mixture 1-0 | 100% | 100% | 100% |
| mixture 1-0.01% Tannic | 100% | 120% | 100% |
| mixture 1-0.05% Tannic | 102% | 207% | 103% |
| mixture 1-0.1% Tannic | 102% | 230% | 105% |
| mixture 2-0 | 100% | 100% | 100% |
| mixture 2-0.01% Tannic | 98% | 123% | 99% |
| mixture 2-0.05% Tannic | 102% | 232% | 95% |
| mixture 2-0.1% Tannic | 102% | 253% | 107% |

### Example 10

A solution of each stabilization additive was prepared (on a w/w basis) targeting final concentrations listed below in 8.5 ml. 0.3 g of dry glycoside mixture was then added to the solution targeting 0.3% final concentration. 1 ml of 1% potassium benzoate was added to each solution at a targeted final concentration of 0.1% (w/w). The solutions were mixed thoroughly to ensure full dissolution. 0.5 ml of IM citric acid solution, pH adjusted to 2.5, was added to each solution to make a final concentration of 0.05M citrate at about pH 3. The solutions were all mixed once again and placed in a refrigerated vessel at 4° C. for 20 hrs. The solutions were filtered with a 0.45 micron syringe filter before analysis by HPLC utilizing the conditions listed above in Example 6. Separate solutions containing only rebaudioside B and the glycoside mixture were also prepared for control comparisons.

TABLE 17

| | | | Concentration (ppm) | | | |
|---|---|---|---|---|---|---|
| | Concentration | pH | Reb A | Stev | Reb B | Total |
| Rebaudioside B | — | 2.97 | 0 | 0 | 154 | 154 |
| Glycoside Mix | — | 2.97 | 1386 | 103 | 273 | 1848 |
| Control | | | | | | |
| Methocel E15 | 0.60% | 2.86 | 1429 | 104 | 663 | 2282 |
| Metarin CP | 0.40% | 2.91 | 1448 | 105 | 902 | 2543 |
| Lecigran 1000P | 0.40% | 2.92 | 1451 | 106 | 891 | 2539 |
| Gum Arabic | 0.60% | 3.00 | 1431 | 107 | 295 | 1923 |
| Guar Gum | 0.10% | 2.96 | 1345 | 99 | 240 | 1767 |
| Xanthan Gum | 0.10% | 2.98 | 1339 | 99 | 188 | 1709 |
| Tragacanth | 0.10% | 2.98 | 1372 | 102 | 260 | 1819 |
| Gum | | | | | | |
| Glycerol | 1.00% | 2.97 | 1383 | 103 | 278 | 1849 |

As shown in Table 17, there is little change between the stability of rebaudioside A and stevioside. However, the stabilization additives have a significant influence on the concentration of rebaudioside B in solution. It was also seen that the presence of other glycosides slightly increased the stability of rebaudioside B in solution. Metarin CP and Lecigran 1000P (deoiled lecithins) stabilized the solution and prevented precipitate from forming.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

Unless otherwise noted, all percents disclosed herein are weight percents.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method for providing an acidic stabilized syrup concentrate containing rebaudioside B comprising:
a) dissolving rebaudioside B in a solution having a pH of from about 7 to about 9 to form a syrup concentrate having a rebaudioside B concentration of at least 500 ppm;
b) adding a stabilizer additive selected from the group consisting of polyoxyethylene having from about 10 to about 100 oxyethylene repeating units that is etherifed with a C 16-19 alkyl alcohol;
sucrose monoesters of lauric, palmitic or stearic acid
polysorbate comprising from about 20 to about 80 oxyethylene repeating units and esterified with a fatty acid selected from lauric acid, palmitic acid, stearic acid and oleic acid;
deoiled lecithins;
tannic acid;
polyoxyethylene octyl phenyl ether;
sodium dodecyl sulfate;
methyl cellulose;
hydroxypropyl methyl cellulose;
gum Arabic; and mixtures thereof to form a stabilized syrup concentrate; and
c) lowering the pH of the syrup concentrate to a pH of about 2 to about 5 to form an acidic stabilized syrup concentrate.

2. The method of claim 1, wherein the stabilizer additive is selected from the group consisting of polyoxyethylene (20) cetyl ether, polyoxyethylene (100) stearyl ether, polyoxyethylene (40) stearate, tannic acid, a sucrose monoester of monopalmitate, a sucrose monoester of palmitate/stearate having a ratio of stearate/palmitate of from 4:1 to 1:4, polyoxyethylenesorbitan monolaurate, polyoxyethylenesorbitan monopalmitate, polyoxyethylenesorbitan monostearate, polyoxyethylene sorbitan monooleate, polyoxyethylene octyl phenyl ether, sodium dodecyl sulfate, methyl cellulose with molecular weight less than 100, hyroxypropyl methyl cellulose, deoiled lecithins, gum Arabic, and mixtures thereof.

3. The method of claim 1, wherein the stabilizer additive is selected from the group consisting of tannic acid, a sucrose monoester of palmitate/stearate having a ratio of stearate/palmitate of from 4:1 to 1:4, polyoxyethylene (20) cetyl ether, and mixtures thereof.

4. The method of claim 1, wherein the syrup concentrate of step a) has a rebaudioside B concentration of from about 500 ppm to about 3000 ppm.

5. The method of claim 1, wherein the stabilizer additive has a weight ratio of about 1:1 to about 5:1 sucrose monoester to methyl cellulose.

6. The method of claim 1, wherein the stabilizer additive has a weight ratio of about 3:1 sucrose monoester to methyl cellulose.

7. The method of claim 5, wherein the sucrose monoester is sucrose monoester of monopalmitate.

8. The method of claim 5, wherein the methyl cellulose is hydroxypropyl methyl cellulose.

9. The method of claim 1, wherein the syrup concentrate of step a) comprises a mixture of steviol glycosides.

10. The method of claim 1, wherein the syrup concentrate of step a) comprises a further steviol glycoside selected from the group consisting of rebaudioside A, rebaudioside C, rebaudioside D, rebaudioside E, rebaudioside F, stevioside, rubusoside, steviolbioside, and dulcoside A and mixtures thereof.

11. The method of claim 1, wherein the ratio of rebaudioside B present in the stabilized syrup concentrate to stabilizer additive present in the stabilized syrup concentrate of step b) is from about 1:0.01 to about 1:1 by weight.

12. The method of claim 1, wherein the ratio of steviol glycosides present in the stabilized syrup concentrate to stabilizer additive present in the stabilized syrup concentrate of step b) is from about 1:0.01 to about 1:1 by weight.

13. The method of claim 1, wherein the pH of the stabilized syrup concentrate is lowered in step c) to a pH of 2-4 to form an acidic stabilized syrup concentrate.

14. The method of claim 1, wherein the pH of the stabilized syrup concentrate is lowered in step c) by addition of a buffer solution.

15. The method of claim 14, wherein the buffer solution comprises an acid selected from the group consisting of citric acid, lactic acid, phosphoric acid, tartaric acid, malic acid, and mixtures thereof.

16. The method of claim 14, wherein the buffer solution comprises sodium citrate and sodium benzoate.

17. The method of claim 1, further comprising the step of
d) removing undissolved solids from the acidic stabilized syrup concentrate.

18. The method of claim 17, wherein the removal of undissolved solids comprises the steps of centrifugation and filtration.

19. The method of claim 17, wherein the removal of undissolved solids comprises the step of decanting a supernatant with subsequent filtration.

20. The method of claim 17, wherein the removal of undissolved solids comprises filtering the stabilized syrup concentrate using a filter having a pore size of less than or equal to about 1 micron.

21. An acidic stabilized syrup concentrate composition comprising;
rebaudioside B at a concentration of at least 500 ppm; and
a stabilizer additive selected from the group consisting of polyoxyethylene having from about 10 to about 100 oxyethylene repeating units that is etherifed with a C 16-19 alkyl alcohol;
sucrose monoesters of lauric, palmitic or stearic acid
polysorbate comprising from about 20 to about 80 oxyethylene repeating units and esterified with a fatty acid selected from lauric acid, palmitic acid, stearic acid and oleic acid;
deoiled lecithins;
tannic acid;
polyoxyethylene octyl phenyl ether;
sodium dodecyl sulfate;
methyl cellulose;
hydroxypropyl methyl cellulose;
gum Arabic; and mixtures thereof; the composition being at a pH from about 2 to about 5.

22. The acidic stabilized syrup concentrate composition of claim 21, wherein the stabilizer additive is selected from the group consisting of polyoxyethylene (20) cetyl ether, polyoxyethylene (100) stearyl ether, polyoxyethylene (40) stearate, tannic acid, a sucrose monoester of monopalmitate, a sucrose monoester of palmitate/stearate having a ratio of stearate/palmitate of from 4:1 to 1:4, polyoxyethylenesorbitan monolaurate, polyoxyethylenesorbitan monopalmitate, polyoxyethylenesorbitan monostearate, polyoxyethylene sorbitan monooleate, polyoxyethylene octyl phenyl ether, sodium dodecyl sulfate, methyl cellulose with molecular weight less than 100, hyroxypropyl methyl cellulose, deoiled lecithins, gum Arabic, and mixtures thereof.

23. The acidic stabilized syrup concentrate composition of claim 21, wherein the stabilizer additive is selected from the group consisting of tannic acid, a sucrose monoester of palmitate/stearate having a weight ratio of stearate/palmitate of from 4:1 to 1:4, polyoxyethylene (20) cetyl ether, and mixtures thereof.

24. The acidic stabilized syrup concentrate composition of claim 21, wherein the stabilizer additive has a weight ratio of about 1:1 to about 5:1 sucrose monoester to methyl cellulose.

25. The acidic stabilized syrup concentrate composition of claim 21, wherein the stabilizer additive has a weight ratio of about 3:1 sucrose monoester to methyl cellulose.

26. The acidic stabilized syrup concentrate composition of claim 21, wherein the sucrose monoester is sucrose monoester of monopalmitate.

27. The acidic stabilized syrup concentrate composition of claim 21, wherein the methyl cellulose is hydroxypropyl methyl cellulose.

28. The acidic stabilized syrup concentrate composition of claim 21, wherein the acidic stabilized syrup concentrate has a rebaudioside B concentration of from about 500 ppm to about 3000 ppm.

29. The acidic stabilized syrup concentrate composition of claim 21, wherein the acidic stabilized syrup concentrate comprises a mixture of steviol glycosides.

30. The acidic stabilized syrup concentrate composition of claim 21, wherein the acidic stabilized syrup concentrate is substantially free of undissolved solids that will not pass through a filter having a pore size of 0.8 micron.

31. The acidic stabilized syrup concentrate composition of claim 21, wherein the acidic stabilized syrup concentrate is substantially free of undissolved solids that will not pass through a filter having a pore size of 0.45 micron.
